(19) United States
(12) Patent Application Publication
(10) Pub. No.: US 2021/0033212 A1
(43) Pub. Date: Feb. 4, 2021

(54) PROPORTIONAL VALVE FOR CONTROLLING A GASEOUS MEDIUM

(71) Applicant: Robert Bosch GmbH, Stuttgart (DE)

(72) Inventor: Michael Kurz, Plochingen (DE)

(21) Appl. No.: 16/634,191

(22) PCT Filed: Jun. 13, 2018
(86) PCT No.: PCT/EP2018/065572

§ 371 Date: Oct. 27, 2020

(30) Foreign Application Priority Data
Jul. 25, 2017 (DE) 10 2017 212 725.2

(51) Int. Cl. F16K 31/40; H01M 8/04746; H01M 8/04089; F16K 31/06; H01M 8/04082; F16K 1/44

(52) U.S. Cl. CPC F16K 31/408; H01M 8/04753; F16K 1/443; F16K 31/0655; H01M 8/04201; H01M 8/04089

(57) ABSTRACT

The invention relates to a proportional valve (1) for controlling a gaseous medium, in particular hydrogen, comprising a valve housing (2), wherein an interior space (9) is formed in the valve housing (2). A first closure element (16) is arranged in the interior space (9), wherein the first closure element (16) cooperates with a first valve seat (19) for opening or closing a first through-opening (14). In addition, a second closure element (36) is arranged in the interior space (9), wherein the second closure element (36) cooperates with a second valve seat (29) for opening and closing a second through-opening (20). The first valve seat (19) is formed on the second closure element (36), wherein the first through-opening (14) feeds into the second through-opening (20).

### BACKGROUND OF THE INVENTION

The invention relates to a proportional valve for controlling a gaseous medium, in particular hydrogen, for example for use in vehicles having a fuel cell drive.

DE 10 2012 204 565 A1 describes a proportional valve for controlling a gaseous medium, in particular hydrogen, wherein the proportional valve comprises a nozzle body, a closure element and an elastic sealing element. In the nozzle body there is formed at least one through-opening which can be freed or closed by the closure element on a valve seat. Here, the elastic sealing element seals at the valve seat and has a recess with an inner wall region. Pressure of the gaseous medium is applied to the inner wall region in the closed state of the proportional valve.

Proportional valves are distinguished by the fact that, upon use thereof, only small pressure fluctuations occur in the anode path of a fuel cell and a smooth operation can be ensured. Frequent opening and closing operations occur in the normal operating range of the proportional valve. Additional switching operations may also be desired for optimizing flushing operations in the anode path of the fuel cell or for optimized operation of a suction jet pump in a fuel cell arrangement. Frequent opening and closing of the proportional valve leads to wear on the valve seat, in particular if a closure element having an elastic sealing element is used. Furthermore, frequent opening and closing of the valve leads to an increased burden on the switching force of the electromagnet, which in turn leads to wear of the entire proportional valve.

### SUMMARY OF THE INVENTION

By contrast, the proportional valve according to the invention for controlling a gaseous medium, in particular hydrogen, has the advantage that, even with high demands on the controllability of the proportional valve, a low switching force of the electromagnet and equally a low spring force or spring stiffness of the springs required during operation are achieved. Consequently, a low degree of wear on the proportional valve is ensured.

For this purpose, the proportional valve for controlling a gaseous medium, in particular hydrogen, has a valve housing. An interior space in which a first closure element is arranged is formed in the valve housing. Here, the first closure element interacts with a first valve seat for opening or closing a first through-opening. Moreover, a second closure element is arranged in the interior space, wherein the second closure element interacts with a second valve seat for opening and closing a second through-opening. The first valve seat is furthermore formed on the second closure element. Furthermore, the first through-opening opens into the second through-opening.

This design promotes a low switching force of the electromagnet for opening the first through-opening. As a result, in addition to reducing the wear, a more precise adjustability of the switching force is achieved. This leads to optimized controllability and functioning of the entire proportional valve. In addition, different throughflow requirements do not impose a new design on the proportional valve since the through-opening can be adapted for this purpose.

In a first advantageous embodiment of the invention, there is provision that the second closure element is pot-shaped and has a recess, wherein the first closure element is received in the recess. As a result, the first through-opening formed in the second closure element can be opened or closed in a simple and installation space-saving manner.

In an advantageous development of the invention, there is provision that the valve housing comprises a nozzle body, on which nozzle body a nozzle is arranged, wherein the second valve seat is formed on the nozzle. Thus, a space-saving and structurally simple assembly of the proportional valve can be achieved.

In a further embodiment of the idea of the invention, an inner elastic sealing element is arranged between the first closure element and the first valve seat. An outer elastic sealing element is advantageously arranged between the second closure element and the second valve seat. The use of an elastic sealing element for example in conjunction with a flat valve seat makes it possible in a simple manner and without major structural modifications to ensure the sealing tightness of the proportional valve.

In an advantageous development of the invention, there is furthermore provision that a through-opening is formed in the nozzle body, wherein the through-opening can be connected to the second through-opening via the second valve seat. As a result, gaseous medium can be channeled from the through-opening in the direction of the second through-opening through the proportional valve.

In an advantageous development of the invention, the interior space comprises a control space, wherein the control space can be connected via the first through-opening to an outflow region at the second through-opening. It is thus possible by changing the pressure conditions in the control space to control the lifting movement of the second closure element and thus the opening of the second through-opening.

In a further embodiment of the invention, there is provision that the interior space comprises a magnet armature space, wherein the magnet armature space is connected via a connecting passage to the through-opening. The pressure in the control space can be influenced by this connection, since gaseous medium can be channeled through the magnet armature space from the through-opening via a leakage into the control space.

In an advantageous development, there is provision that a magnet armature device which is movable in a reciprocating manner is arranged in the magnet armature space, which magnet armature device is fixedly connected to the first closure element. An electromagnet is advantageously arranged in the interior space, wherein the magnet armature device can be moved in a reciprocating manner by the electromagnet.

In a further embodiment of the invention, a closure spring is arranged in the interior space between the valve housing and the magnet armature device, wherein the closure spring applies a force to the magnet armature device in the direction of the second through-opening. This ensures the sealing tightness of the proportional valve in the switched-off state, with the result that no gaseous medium can flow through the proportional valve.

In an advantageous development of the invention, there is provision that a further spring is arranged between the nozzle and the second closure element, wherein the spring applies a force to the second closure element in the direction of the magnet armature device. The further spring allows the lifting movement of the second closure element and thus the opening of the second through-opening to be accelerated.

In an advantageous development of the invention, the control space and the magnet armature space are connected to one another via a connecting bore. As a result, the control volume of gaseous medium in the control space can be increased. The control space and the through-passages are advantageously fluidically connected to one another. In this case, quicker closing of the entire proportional valve occurs. The opening and closing operation of the proportional valve can thus be influenced via connections of the through-passages to the magnet armature space, the control space and the outflow region.

The proportional valve described is preferably suitable in a fuel cell arrangement for controlling a hydrogen feed to an anode region of a fuel cell. Advantages are the low pressure fluctuations in the anode path and a smooth operation.

### BRIEF DESCRIPTION OF THE DRAWINGS

Exemplary embodiments of a proportional valve according to the invention for controlling a gas feed, in particular hydrogen, to a fuel cell are illustrated in the drawing, in which

FIG. 1 shows a first exemplary embodiment of a proportional valve according to the invention having two closure elements in longitudinal section,

FIG. 2a shows the exemplary embodiment from FIG. 1 in the closed state,

FIG. 2b shows the exemplary embodiment from FIG. 1 upon opening of the proportional valve,

FIG. 2c shows the exemplary embodiment from FIG. 1 in an opened state,

FIG. 3 shows a further exemplary embodiment of the proportional valve according to the invention having two closure elements in longitudinal section, and

FIG. 4 shows a further exemplary embodiment of the proportional valve according to the invention having two closure elements in longitudinal section.

Components having the same function have been designated with the same reference number.

### DETAILED DESCRIPTION

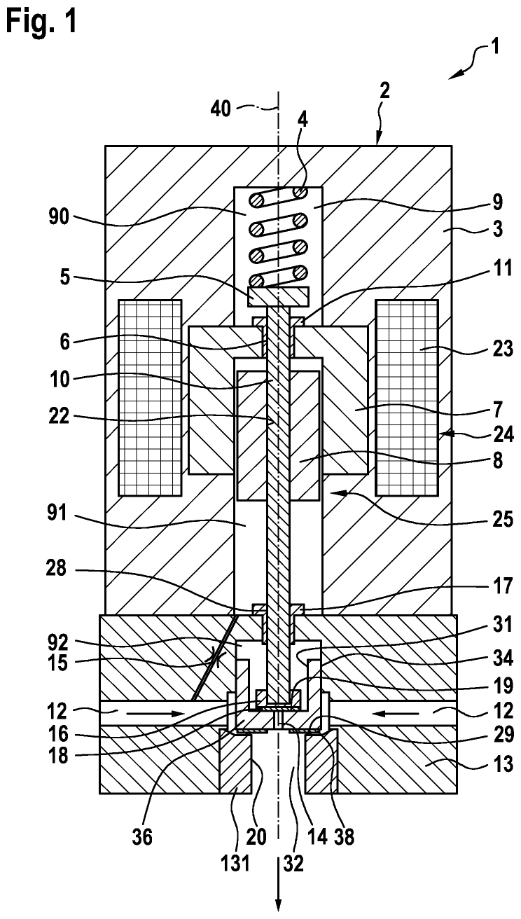

FIG. 1 shows a first exemplary embodiment of a proportional valve 1 according to invention in longitudinal section. The proportional valve 1 has a valve housing 2, the valve housing 2 comprising a holding body 3 and a nozzle body 13 which are connected to one another in a gastight manner. A nozzle 131 is received in the nozzle body 13. An electromagnet 24 is arranged in the proportional valve 1, the electromagnet 24 comprising a magnet coil 23 and a magnet core 7. Furthermore, an interior space 9 is formed in the valve housing 2, in which interior space 9 there is arranged a magnet armature device 25 which is movable in a reciprocating manner.

The magnet armature device 25 comprises a magnet armature 8 and a cylindrical connecting element 10, the connecting element 10 being received in an aperture 22 in the magnet armature 8 and thus being fixedly connected to the magnet armature 8, for example by a weld seam or by pressing. The magnet armature 8 takes the form of a plunger-type armature and is received in the magnet core 7. The connecting element 10 is received and guided in an aperture in the magnet core 7 at a first seal 11 on a first guide portion 6.

The valve housing 2 and the magnet core 7 delimit a spring space 90 which forms part of the interior space 9. In the spring space 90 there is formed a closure spring 4 which is supported between the valve housing 2 and a disk-shaped end 5 of the connecting element 10. The closure spring 4 applies a force to the magnet armature device 25 in the direction of the nozzle body 13. The interior space 9 furthermore comprises a magnet armature space 91 which is delimited by the valve housing 2, the magnet core 7 and the nozzle body 13. The magnet armature 8 is arranged in this magnet armature space 91.

Two through-passages 12 are formed in the nozzle body 13 perpendicular to a longitudinal axis 40 of the proportional valve 1, with the result that the interior space 9 can be filled with gaseous medium, for example hydrogen. In the nozzle body 13 there is formed a connecting passage 15 via which gaseous medium can enter the magnet armature space 91 from the through-passages 12 in a throttled manner. A second guide portion 28 for the connecting element 10 of the magnet armature device 25 is formed on the nozzle body 13 at a second seal 17.

A first closure element 16 is arranged on the end opposite to the disk-shaped end 5 of the connecting element 10. This first closure element 16 is fixedly connected to the connecting element 10, for example by a weld seam or by pressing. Furthermore, an inner elastic sealing element 18 which is disk-shaped adjoins the first closure element 16 and is fixedly connected thereto.

Furthermore, a second closure element 36 is arranged in the interior space 9 and is received and guided at a guide region 34 in the nozzle body 13. The second closure element 36 is pot-shaped and has a recess 31. The connecting element 10 and the first closure element 16 with the inner elastic sealing element 18 are received in this recess 31. A first through-opening 14 is formed in the second closure element 36, wherein the first closure element 16 interacts with a first valve seat 19 on the second closure element 36 for opening and closing the first through-opening 14. The first valve seat 19 is of flat design.

The first through-opening 14 opens into a second through-opening 20 formed in an outflow region 32. An outer elastic sealing element 38 which is disk-shaped adjoins the second closure element 36 and is fixedly connected thereto. The second closure element 36 thus seals the second through-opening 20 upon placing the outer elastic sealing element 38 against a second valve seat 29 formed on the nozzle 131, with the result that no gaseous medium can pass out of the proportional valve 1. The second valve seat 29 is functionally designed in such a way that it is partially subjected to the pressure in the through-passages 12, with the result that a force acts in the opening direction, that is to say in the direction of the magnet armature device 25. However, with the magnet coil 23 deenergized, this force is smaller than the force of the closure spring 4, with the result that the second through-opening 20 is sealed by the second closure element 36.

The second closure element 36 and the nozzle body 13 delimit a control space 92, the interior space 9 comprising the control space 92. A leakage is formed at the second seal 17 at the second guide portion 28 of the connecting element 10, with the result that the control space 92 is fluidically connected to the magnet armature space 91. The control space 92 can be connected to the outflow region 32 via the first through-opening 14.

Mode of Operation of the First Exemplary Embodiment

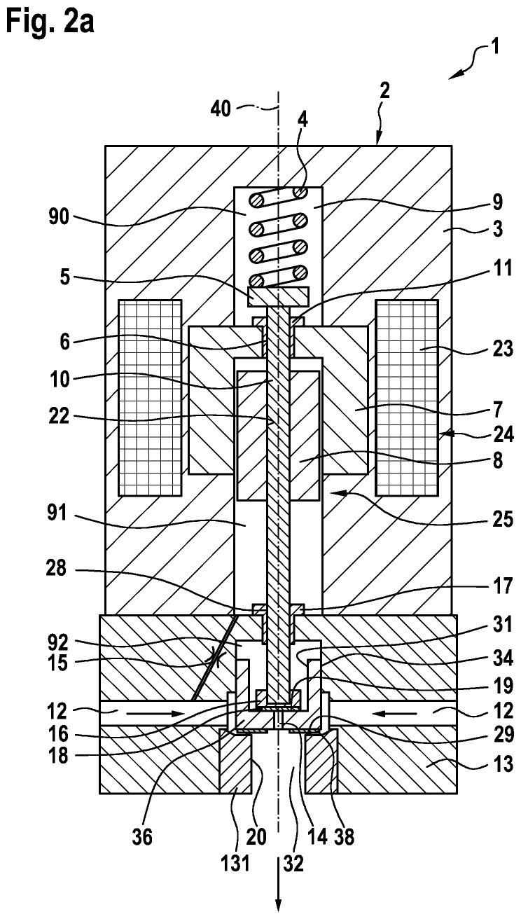

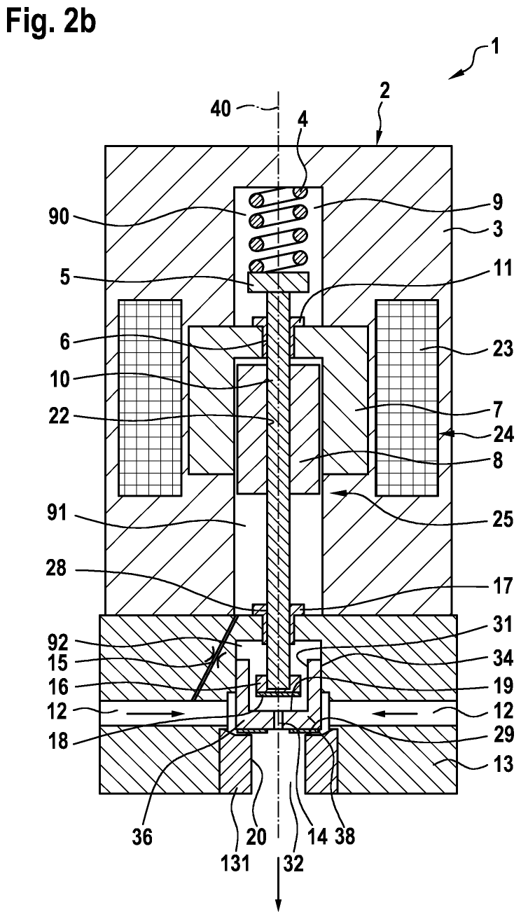

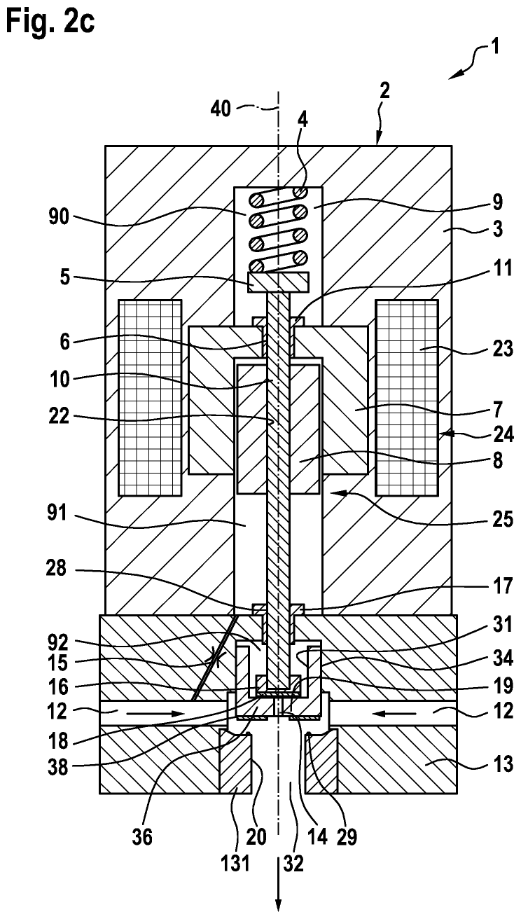

FIG. 2a shows the proportional valve 1 from FIG. 1 in the switched-off state. With the magnet coil 23 not energized, the first closure element 16 is pressed via the force of the closure spring 4 by means of the magnet armature device 25 against the first valve seat 19 and the second closure element 36 is pressed against the second valve seat 29, with the result that the first through-opening 14 and the second through-opening 20 are blocked. No gaseous medium can thus flow through the proportional valve 1. The same pressure as in the through-passages 12 prevails in the magnet armature space 91 and the control space 92 by virtue of the connecting passage 15. The pressure is lower in the outflow region 32 than in the control space 92.

FIG. 2b shows the exemplary embodiment from FIG. 1 with the magnet coil 23 energized. When the magnet coil 23 is energized, a magnetic force is generated on the magnet armature 8, said force being directed oppositely to the force of the closure spring 4. If the force of the closure spring 4 is overcompensated by the magnetic force, the magnet armature device 25 moves in the direction of the spring 4. The first closure element 16 lifts from the first valve seat 19. A throughflow of gas from the control space 92 via the first through-opening 14 into the second through-opening 20 and thus into the outflow region 32 is enabled.

The second closure element 36 also lifts from the second valve seat 29 by virtue of the pressure equalization of the control space 92 with the outflow region 32, which is not very adversely affected by the leakage at the second seal 17 at the second guide portion 28 of the connecting element 10, and the pressure infiltration under the second valve seat 29 by the gaseous medium from the through-passages 12. The second through-opening 20 is now also freed, as shown in FIG. 2c. The second closure element 36 here follows the lifting movement of the first closure element 16 and catches up with the first closure element 16. Consequently the first closure element 16 again bears against the first valve seat 19 and thus closes the first through-opening 14.

The lift of the first closure element 16 and hence of the second closure element 36 can be adjusted via the level of the current intensity at the magnet coil 23. The higher the current intensity at the magnet coil 23, the greater the lift of the first closure element 16 or of the second closure element 36 and the higher also the throughflow of gas in the proportional valve 1, since the force of the closure spring 4 is lift-dependent. If the current intensity at the magnet coil 23 is reduced, the lift of the first closure element 16 or of the second closure element 36 is also reduced and thus the throughflow of gas is throttled.

If the magnet armature device 25 remains over a relatively long period of time in the same opening position, a pressure which is greater than the pressure in the outflow region 32 builds up in the control space 92 on account of leakage at the second seal 17 at the second guide portion 28 of the connecting element 10. Consequently, the second closure element 36 moves in the direction of the second through-opening 20, with the result that the first valve seat 19 and thus the first through-opening 14 are freed. A renewed pressure equalization of the control space 92 with the outflow region 32 again leads to closure of the first through-opening 14. This effect leads to a slight oscillation of the second closure element 36 around the set position of the magnet armature device 25.

If the current at the magnet coil 23 is interrupted, the magnetic force on the magnet armature 8 is reduced, with the result that the force on the magnet armature device 25 is reduced. The magnet armature device 25 and the first closure element 16 move simultaneously with the second closure element 36 in the direction of the second through-opening 20, the second closure element 36 providing sealing at the second valve seat 29 by way of the outer elastic sealing element 38. The throughflow of gas in the proportional valve 1 is interrupted.

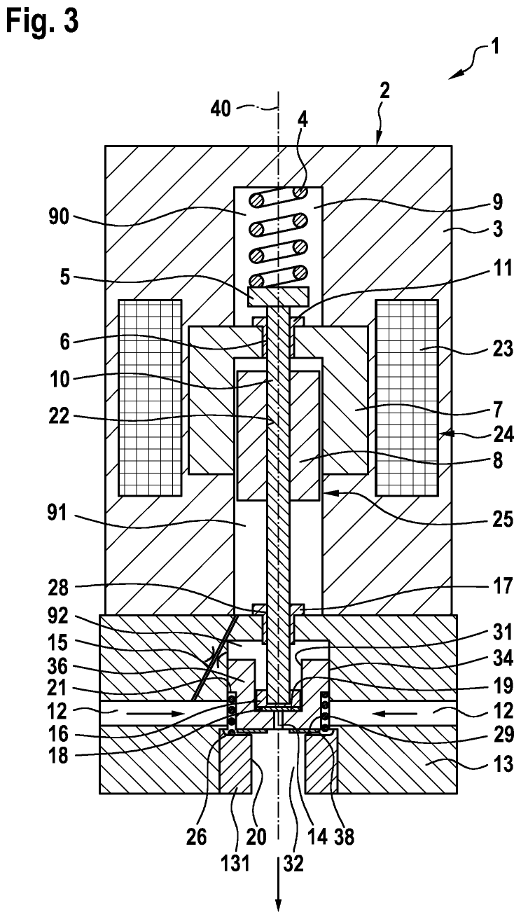

FIG. 3 shows a further exemplary embodiment of the proportional valve 1 according to the invention in longitudinal section. Components having the same function have been designated with the same reference number as in FIG. 1. Here, in addition to the exemplary embodiment from FIG. 1, a further spring 26 is arranged in the proportional valve 1. This spring 26 is supported between a shoulder 21 on the second closure element 36 and the end of the nozzle 131 on which the second valve seat 29 is also formed. The use of a further spring 26 and the additional pressure infiltration under the shoulder 21 by the pressure in the through-passages 12 result in the second closure element 36 being lifted earlier from the second valve seat 29 and following the lifting movement of the first closure element 16 more quickly. That is to say that a slight pressure reduction in the control space 92 is sufficient to achieve a lifting movement of the second closure element 36. With the magnet coil 23 deenergized, the closure spring 4 overpresses the further spring 26, with the result that the first closure element 16 and the second closure element 36 do not free the first through-opening 14 and the second through-opening 20 in the closed position.

The basic mode of operation of the further exemplary embodiment is the same as that of the first exemplary embodiment.

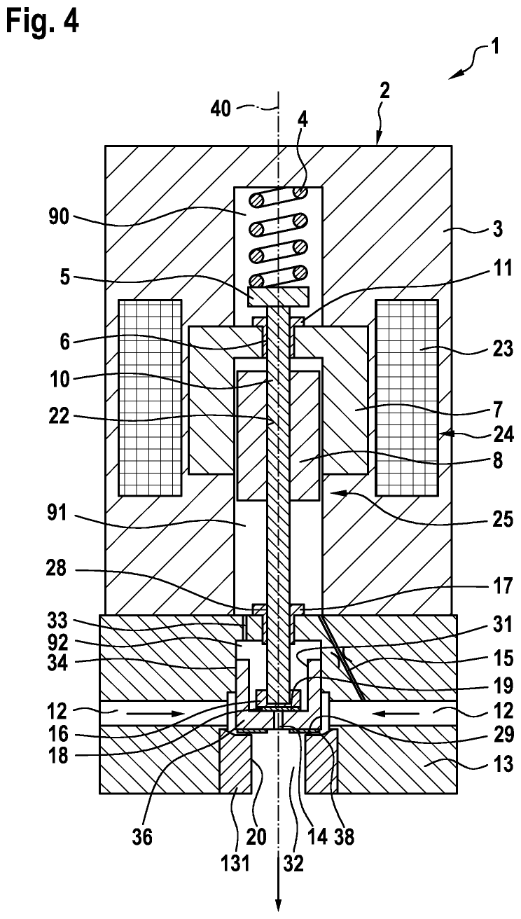

FIG. 4 shows a further exemplary embodiment of the proportional valve 1 according to the invention in longitudinal section. Components having the same function have been designated with the same reference number as in FIG. 1. Here, in addition to the exemplary embodiment from FIG. 1, a connecting bore 33 is formed in the nozzle body 13, with the result that the magnet armature space 91 is connected to the control space 92. In this way, the control volume of gaseous medium in the control space 92 can be increased. The result of this is that the closure of the entire proportional valve 1 proceeds more quickly.

The basic mode of operation of the further exemplary embodiment is the same as that of the first exemplary embodiment.

A connection by means of a bore or throttle between the through-passages 12 and the control space 92 also increases the control volume of gaseous medium in the control space 92 and thus likewise leads to a quicker closure of the entire proportional valve 1. Furthermore, the opening or closing operation of the entire proportional valve 1 can be influenced by connections of the through-passages 12 to the magnet armature space 91 and the control space 92 and also to the outflow region 32.

The proportional valve 1 according to the invention can be used for example in a fuel cell arrangement. Hydrogen from a tank can be fed by means of the proportional valve 1 to an anode region of the fuel cell. Depending on the level of the current intensity at the magnet coil 23 of the proportional valve 1 by which the lift of the closure element 16 and thus of the second closure element 36 is actuated, a flow cross section at the second through-opening 20 is thus changed in such a way that there continuously occurs a requirement-appropriate adjustment of the gas flow fed to the fuel cell.

The proportional valve 1 for controlling a gaseous medium thus has the advantage that here the feeding of the first gaseous medium and the metering of hydrogen into the anode region of the fuel cell can occur in a substantially more exact manner by means of electronically controlled adaptation of the flow cross section of the second through-opening 20 with simultaneous control of the anode pressure. As a result, the operational reliability and durability of the connected fuel cell are considerably improved, since hydrogen is always fed in a superstoichiometric fraction. In addition, secondary damage, such as damage to a downstream catalyst, for example, can also be prevented.

1. A proportional valve (1) for controlling a gaseous medium, the proportional valve (1) having a valve housing (2), wherein an interior space (9) is formed in the valve housing (2), wherein a first closure element (16) is arranged in the interior space (9), wherein the first closure element (16) interacts with a first valve seat (19) for opening or closing a first through-opening (14), wherein a second closure element (36) is arranged in the interior space (9), wherein the second closure element (36) interacts with a second valve seat (29) for opening and closing a second through-opening (20), wherein the first valve seat (19) is formed on the second closure element (36) and wherein the first through-opening (14) opens into the second through-opening (20).

2. The proportional valve (1) for controlling a gaseous medium as claimed in claim 1, characterized in that the second closure element (36) is pot-shaped and has a recess (31), wherein the first closure element (16) is received in the recess (31).

3. The proportional valve (1) for controlling a gaseous medium as claimed in claim 1, characterized in that the valve housing (2) comprises a nozzle body (13), on which a nozzle (131) is arranged, wherein the second valve seat (29) is formed on the nozzle (131).

4. The proportional valve (1) for controlling a gaseous medium as claimed in claim 1, characterized in that an inner elastic sealing element (18) is arranged between the first closure element (16) and the first valve seat (19).

5. The proportional valve (1) for controlling a gaseous medium as claimed in claim 1, characterized in that an outer elastic sealing element (38) is arranged between the second closure element (36) and the second valve seat (29).

6. The proportional valve (1) for controlling a gaseous medium as claimed in claim 3, characterized in that two through-passages (12) are formed in the nozzle body (13), wherein the through-passages (12) are configured to be connected to the second through-opening (20) via the second valve seat (29).

7. The proportional valve (1) for controlling a gaseous medium as claimed in claim 6, characterized in that the interior space (9) comprises a control space (92), wherein the control space (92) is configured to be connected via the first through-opening (14) to an outflow region (32) at the second through-opening (20).

8. The proportional valve (1) for controlling a gaseous medium as claimed in claim 7, characterized in that the interior space (9) comprises a magnet armature space (91), wherein the magnet armature space (91) is connected via a connecting passage (15) to the through-passages (12).

9. The proportional valve (1) for controlling a gaseous medium as claimed in claim 8, characterized in that a magnet armature device (25), which is movable in a reciprocating manner, is arranged in the magnet armature space (91), wherein the magnet armature device (25) is fixedly connected to the first closure element (16).

10. The proportional valve (1) for controlling a gaseous medium as claimed in claim 9, characterized in that an electromagnet (24) is arranged in the interior space (9), wherein the magnet armature device (25) is configured to be moved in a reciprocating manner by the electromagnet (24).

11. The proportional valve (1) for controlling a gaseous medium as claimed in claim 9, characterized in that a closure spring (4) is arranged in the interior space (9) between the valve housing (2) and the magnet armature device (25), wherein the closure spring (4) applies a force to the magnet armature device (25) in the direction of the second through-opening (20).

12. The proportional valve (1) for controlling a gaseous medium as claimed in claim 9, characterized in that a further spring (26) is arranged between the nozzle (131) and the second closure element (36), wherein the spring (26) applies a force to the second closure element (36) in the direction of the magnet armature device (25).

13. The proportional valve (1) for controlling a gaseous medium as claimed in claim 8, characterized in that the control space (92) and the magnet armature space (91) are connected to one another via a connecting bore (33).

14. The proportional valve (1) for controlling a gaseous medium as claimed in claim 7, characterized in that the control space (92) and the through-passages (12) are fluidically connected to one another.

15. A fuel cell arrangement having a proportional valve (1) as claimed in claim 1, the proportional valve being configured for controlling a hydrogen feed to a fuel cell.
